(19) United States
(12) Patent Application Publication
(10) Pub. No.: US 2005/0182585 A1
(43) Pub. Date: Aug. 18, 2005

(54) Structure and method for package burn-in testing

(76) Inventor: Wen-Kun Yang, Hsinchu (TW)

Correspondence Address: NATH & ASSOCIATES, 1030 15th STREET, NW, 6TH FLOOR, WASHINGTON, DC, 20005, US

(21) Appl. No.: 10/840,421

(22) Filed: May 7, 2004

(30) Foreign Application Priority Data
Feb. 16, 2004 (TW) 93103677

(51) Int. Cl. G06F 19/00

(52) U.S. Cl. 702/117

(57) ABSTRACT

The present invention discloses a contact structure and method for burn-in testing. The structure comprises a print circuit board, metal solder join fixed to the print circuit board, and contact fixed plate. The contact metal springs are located on the metal solder join and contacted with contact metal balls. The metal solder join is located on the contact fixed plate. Between the contact metal balls and the contact metal springs keep an approximately constant pressure and self-alignment by using the surface of the fixed plate contacting with the surface of the ball grid array (BGA) package.

### BACKGROUND OF THE INVENTION

1. Field of the Invention

This invention relates to a contact apparatus and method of burn-in testing after packaging, and more particularly to a new type contact structure and method by using contact pressure of conductive micro springs, can apply to a conventional package or wafer level package to improve burn-in procedure.

2. Description of the Prior Art

The semiconductor technologies are developing very fast, and especially semiconductor dies have a tendency toward miniaturization.

However, the requirements for the functions of the semiconductor dies have an opposite tendency to variety. Namely, the semiconductor dies must have more I/O pads into a smaller area, so the density of the pins is raised quickly. It causes the packaging for the semiconductor dies to become more difficult and decrease the yield.

The main purpose of the package structure is to protect the dies from outside damages. Furthermore, the heat generated by the dies must be diffused efficiently through the package structure to ensure the operation the dies.

The earlier lead frame package technology is already not suitable for the advanced semiconductor dies due to the density of the terminals thereof is too high. Hence, a new package technology of BGA (Ball Grid Array) has been developed to satisfy the packaging requirement for the advanced semiconductor dies. The BGA package has an advantage of that the spherical terminals has a shorter pitch than that of the lead frame package, and the terminals of the BGA are unlikely to be damage and deform. In addition, the shorter signal transmitting distance benefits to raise the operating frequency to conform to the requirement of faster efficiency. Most of the package technologies divide dice on a wafer into respective dies and then to package and test the die respectively. Another package technology, called “Wafer Level Package (WLP)”, can package the dies on a wafer before dividing the dice into respective individual die. The WLP technology has some advantages, such as a shorter producing cycle time, lower cost, and no need to under-fill or molding.

Moreover, the packaged IC continues a series of testing in a conventional package or wafer level package. The contact method of burn-in and test socket in present marketing comprises three type as follows, (1) Pogo Pin: high price and cost of burn-in testing, (2) Metal probe: common reliability, high price and assembly complicated, (3) Membrane contact: high price and low reliability.

In view of the aforementioned drawbacks, a new type contact structure and method of burn-in and test provided by the present invention can improve the above drawbacks. That is to say, the present invention has the advantages as follows: high reliability, low cost, easy assembly and easy to repair. Besides, the present invention can apply to a conventional package and wafer level package etc..

### SUMMARY OF THE INVENTION

The objective of the present invention is to provide a contact structure and method of bum-in and test after packaging.

Another objective of the present invention is to provide a contact structure and method of burn-in and test of the new type wafer level package after packaging. The contact structure of burn-in and test of new type wafer level package disclosed of the present invention can apply to a wafer level package having a plurality of contact metal balls. The test structure of die comprises a print circuit board, a solder join and a fixed plate. The solder join is fixed on the print circuit board, and the solder join has a plurality of contact metal springs being connected with the contact metal balls. The fixed plate is located among the solder join. A substantially constant pressure is kept between the contact metal balls and the metal springs by using surface of the fixed plate contacting with surface of the wafer level package. The present invention also provided a self-alignment method. The bore diameter of the lowest plate is the smallest one, the bore diameter of the highest plate is the largest one.

The contact method of burn-in and test of new type wafer level package disclosed of the present invention comprises the following steps: firstly, providing a wafer level package (BGA/CSP) having a plurality of contact metal balls. Next, a print circuit board is provided. And then, a solder join and a fixed plate are fixed on the print circuit board, and metal springs located in the solder join are electrically coupled with the contact metal balls. The contact pressure between the contact metal balls and the metal springs keep an approximately constant by using surface of the fixed plate contacting with surface of the wafer level package.

### BRIEF DESCRIPTION OF THE DRAWINGS

The above objects, and other features and advantages of the present invention will become more apparent after reading the following detailed description when taken in conjunction with the drawings, in which:

FIG. 1 is a schematic diagram of a contact structure of burn-in and test of new type wafer level package of the present invention.

### DESCRIPTION OF THE PREFERRED EMBODIMENT

The present invention discloses a structure and method of burn-in and test for the new type package. It can apply to a testing of a conventional type or wafer level package. Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

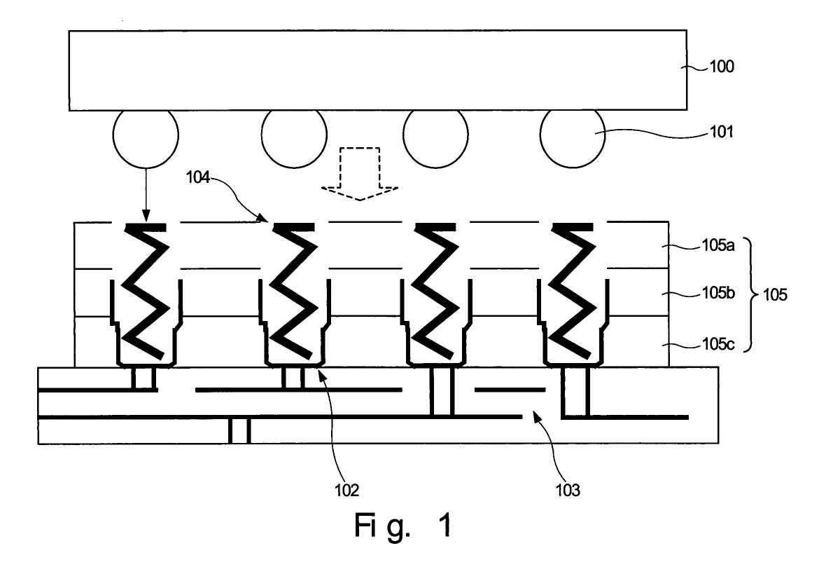

As shown in FIG. 1, it is a schematic diagram of a contact structure of burn-in and test for package. The ball grid array (BGA) package 100 will now be described but it is not used to limit the present invention. The package 100 has a plurality of contact metal balls 101. The contact metal balls 101 may be formed by conductive material, such as solder balls.

Solder join 102 is fixed on a print circuit board (PCB) 103. In one embodiment, the solder join 102 is fixed on the print circuit board 103 by SMT technique. The print circuit board 103 is heat-resistant material, such as FR4, FR5 or BT etc.. One feature of the solder join 102 comprises that width of upper portion of the opening is wider than that of lower portion of the opening in tangent plane of the solder join 102. Therefore, fixed plate 104 is constructed by a plurality of plates, including upper plate 105a, middle plate 105b and lower plate 105c, wherein bore diameter of the lower plate 105c is minimum one, and bore diameter of the upper plate 105a is maximum one. Of course, a whole shaping fixed plate 104 may be used.

Contact micro metal springs 104 are located on the solder join 102. The micro metal springs 104 are fixed on the solder join 102. The micro metal springs 104 may be contacted with the solder balls 101. The material of the micro metal springs 104 include conductive material, such as metal, alloy etc.., preferable stainless steel. A substantially constant pressure is created between the solder balls and the metal springs. The ball may self-align into the hole of the plates. The pressure of the solder balls keeps independent. The micro metal springs 104 are located on the print circuit board to electrically couple with conductive circuit.

Surfaces of the fixed plate 105 and the micro metal springs 104 are approximately or substantially at same level, and material of the fixed plate 105 and the print circuit board 103 is the same or similar, such as FR4, FR5 or BT etc.. Besides, the fixed plate 105 is located among the solder join 102. The solder balls 101 continue downward pressing after contacting with the micro metal springs 104, and depth of pressing such as is 380 micron. Because the fixed plate 105 and the micro metal springs 104 are approximately at same level, the depth of pressing of the solder balls 101 can not exceed diameter of the solder balls 101. Therefore, an approximately constant and self-aligned pressure is kept between the solder balls 101 and the micro metal springs 104 by using the surface of the fixed plate 105 contacting with the surface of the ball grid array (BGA) package 100.

The contact method of burn-in and test of new type wafer level package disclosed of the present invention comprises the following steps: firstly, providing a package 100 with BGA having a plurality of solder balls 101. Next, a print circuit board 103 is provided. And then, a solder join 102 and a fixed plate 105 are fixed on the print circuit board 103, and metal springs 104 located in the solder join 102 are electrically coupled to the solder balls 101. Between the solder balls 101 and the metal springs 104 keeps an approximately constant pressure by using surface of the fixed plate 105 contacting with surface of the wafer level package (BGA) 100.

In one embodiment, the solder join 102 is fixed on the print circuit board 103 by SMT technique. The print circuit board 103 is heat-resistant material, such as FR4, FR5 or BT etc.. Surfaces of the fixed plate 105 and the metal springs 104 are approximately at same level, and material of the fixed plate 105 and the print circuit board 103 is the same, such as FR4, FR5 or BT etc.. Moreover, the fixed plate 105 is located among the solder join 102. Material of the metal springs 104 is stainless steel.

The contact structure and method of burn-in and test of new type wafer level package has the advantages as follows: contact pressure is kept between the solder balls and the metal springs, each ball contact independently to a spring, longer contacting life time, not easy to damage the contact spring, easy to repair the contact micro spring, easy assembly, the lowest cost, and can be used for burn-in and test for WLP and Multi-package after packaging.

Although specific embodiments have been illustrated and described, it will be obvious to those skilled in the art that various modifications may be made without departing from what is intended to be limited solely by the appended claims.

1. A contact structure for burn-in testing after packaging, comprising:
a print circuit board;
a fixed plate located on said print circuit board; and
a solder join fixed on said fixed plate, said solder join having a plurality of contact metal springs being electrically connected with said print circuit board and be used to contact to a testing object;
wherein said fixed plate contacts to a surface of said testing object to keep an substantially constant pressure between the contact metal balls and said contact metal springs.

2. The structure in claim 1, wherein said contact metal balls, such as solder balls, are attached to said package.

3. The structure in claim 1, wherein said metal springs is fixed on said solder join, and material of said metal springs comprises stainless steel.

4. The structure in claim 1, wherein said solder join is fixed on said print circuit board by SMT technique.

5. The structure in claim 1, wherein said print circuit board is heat-resistant material.

6. The structure in claim 5, wherein said heat-resistant material is selected from FR4, FR5 or BT.

7. The structure in claim 1, wherein surfaces of said fixed plate and said metal springs are at same level, and material of said fixed plate and said print circuit board is the same.

8. The structure in claim 1, wherein said fixed plate is constructed by a plurality of plates, and bore diameter of the lowest plate is smallest one, bore diameter of the highest plate is the largest one.

9. A contact method of burn-in and test after packaging, comprising:
providing a print circuit board; and
fixing a solder join and a fixed plate on said print circuit board, metal springs located in said solder join being electrically coupled with package, and utilizing the surface of said fixed plate to form a substantially contact pressure between said package and said metal springs.

10. The method in claim 9, further comprising contact metal balls, such as solder balls, attached to said package.

11. The method in claim 9, wherein said metal springs is fixed on said solder join, and material of said metal springs comprises stainless steel.

12. The method in claim 9, wherein said solder join is fixed on said print circuit board by SMT technique.

13. The method in claim 9, wherein said print circuit board is heat-resistant material.

14. The method in claim 13, wherein said heat-resistant material is selected from FR4, FR5 or BT.

15. The structure in claim 9, wherein surfaces of said fixed plate and said metal springs are at same level, and material of said fixed plate and said print circuit board is the same.

16. The structure in claim 9, wherein said fixed plate is constructed by a plurality of plates, and the bore diameter of the lowest plate is the smallest one, the bore diameter of the highest plate is the largest one.
